(19) United States
(12) Patent Application Publication
(10) Pub. No.: US 2014/0009989 A1
(43) Pub. Date: Jan. 9, 2014

(54) High-efficiency Switching Power converter and method for enhancing switching power conversion efficiency

(71) Applicants: Yu-Chih Lin, Taipei (TW); Shao-Chung Chen, Taipei (TW)

(72) Inventors: Yu-Chih Lin, Taipei (TW); Shao-Chung Chen, Taipei (TW)

(21) Appl. No.: 13/541,686

(22) Filed: Jul. 4, 2012

(51) Int. Cl. G05F 1/46; H02M 7/537; H02M 7/5387

(52) U.S. Cl. 363/132; 323/282; 363/131

(57) ABSTRACT

A switching power converter has a power converter connected between a DC power source and a load and having a power switch, a current detector detecting a load current, and a PWM controller outputting a first frequency to control the switching frequency of the power switch and outputting an adjustable second frequency to adjust the switching frequency of the power switch according to the load current and a condition of judgment. The condition of judgment serves to determine if the load is a heavy or light load. In the case of light load, the second frequency is reduced to lower the switching loss of the power switch. In the case of heavy load, the second frequency is raised to reduce the ripple of the load current. Accordingly, the conversion efficiency of the switching power converter can be enhanced.

### BACKGROUND OF THE INVENTION

1. Field of the Invention

The present invention relates to a switching power converter and more particularly to a high-efficiency switching power converter.

2. Description of the Related Art

Conventional switching power converters normally serve to supply DC input power to loads through power converters. Each of the conventional switching power converters has at least one power switch. When each one of the at least one power switch is turned on or off, the DC power is connected to or disconnected from the load. A pulse width modulation (PWM) controller using the PWM means drives the power converter to switch the at least one power switch. The PWM means compares a reference voltage with a load voltage of the load and then outputs a control signal. Based on a calculation with the control signal and a load current, the PWM controller outputs a fixed switching frequency and a different pulse width to control the time for the at least one power switch to turn on. When the load voltage is lower than the reference voltage or the load current increases, a heavy load is applied. The PWM controller then increases the output pulse width to increase the time for the at least one power switch to turn on and raise output voltage of the power converter. When the load voltage is higher than the reference voltage or the load current decreases, a light load is applied. The PWM controller then decreases the output pulse width to decrease the time for the at least one power switch to turn on and lower output voltage of the power converter.

It is known that the power switch is a transistor in the power converter of the switching power converter. Switching power loss and heat generation occur between when the transistor turns off and turns on or vice versa. During a light load, the higher switching frequency leads to more switching loss of the transistor to therefore reduce the efficiency of the switching power converter. During a heavy load, the lower switching frequency leads to excessively large ripple current. Therefore, the unsatisfactory conversion efficiency of the conventional switching power converter using fixed switching frequency should be tackled with a better solution.

### SUMMARY OF THE INVENTION

A first objective of the present invention is to provide a high-efficiency switching power converter capable of adjusting switching frequency thereof according to a loading condition and enhancing conversion efficiency of the switching power converter.

To achieve the foregoing objective, the high-efficiency switching power converter has a power converter, a current detector, a frequency-varying controller and a PWM controller.

The power converter has two input terminals, two output terminals, at least one power switch, and at least one control terminal. The input terminals are adapted to connect to a DC power source. The output terminals are adapted to connect to a load. The at least one power switch is connected between the two input terminals and the two output terminals. The at least one control terminal controls the at least one power switch to switch.

The current detector has two input terminals and an output terminal. The input terminals are respectively connected to the power converter and the load.

The frequency-varying controller has multiple input terminals and an output terminal. One of the input terminals is connected to the output terminal of the current detector, and the remaining input terminals respectively receive at least one current setting value.

The feedback circuit has three input terminals and an output terminal. Two of the three input terminals are respectively connected to one of the output terminals of the power converter and the output terminal of the current detector. The remaining input terminal receives a voltage setting value.

The PWM controller has at least one output terminal, a feedback control terminal and a frequency control signal terminal. The at least one output terminal is respectively connected to the at least one control terminal of the power converter. The feedback control terminal is connected to the output terminal of the feedback circuit. The frequency control signal terminal is connected to the output terminal of the frequency-varying controller.

The power converter is connected between the DC power source and the load. The PWM controller outputs a first frequency to control the switching frequency of the power switch. The current detector detects a load current value and sends the load current value to the frequency-varying controller for comparing the load current value with at least one current setting value. The at least one current setting value serves as a basis for determining if the load is a light load or a heavy load. After determining the loading condition, the frequency-varying controller outputs a frequency-varying signal for light load or heavy load to the PWM controller. The feedback circuit generates a feedback signal based on the load voltage and the load current and sends the feedback signal to the PWM controller. The PWM controller outputs an adjustable second frequency according to the feedback signal and the frequency-varying signal for light load or heavy load to adjust the switching frequency of the power switch. In case of light load, the second frequency is set to be lower than the first frequency to lower the switching frequency of the power switch and reduce the switching loss. In case of heavy load, the second frequency is set to be higher than the first frequency to reduce the ripple of the load current. Accordingly, the switching power converter can have lower switching loss and higher conversion efficiency.

A second objective of the present invention is to provide a method for enhancing switching power conversion efficiency capable of adjusting switching frequency and enhancing conversion efficiency of a switching power converter according to a loading condition.

The method is performed by a switching power converter. The switching power converter is connected to a load, stores a reference current value, and has a power converter. The power converter has at least one power switch and a PWM controller. The PWM controller controls a switching frequency of each one of the at least one power switch. The method comprising the following steps.

The PWM controller controls a switching frequency of each one of the at least one power switch with an initial frequency.

The switching power converter acquires a load current value of the load.

The switching power converter compares the load current value with the reference current value.

The switching power converter generates a frequency-varying signal according to the load current value and the comparison result and sends the frequency-varying signal to the PWM controller.

The PWM controller decreases or increases the switching frequency of each one of the at least one power switch according to the frequency-varying signal.

Other objectives, advantages and novel features of the invention will become more apparent from the following detailed description when taken in conjunction with the accompanying drawings.

### BRIEF DESCRIPTION OF THE DRAWINGS

FIG. 1 is a flow diagram of a method for enhancing switching power conversion efficiency in accordance with the present invention;

FIG. 2 is a functional block diagram of a first embodiment of a high-efficiency switching power converter in accordance with the present invention;

FIG. 3 is a circuit block diagram of the high-efficiency switching power converter in FIG. 2;

FIG. 4 is a circuit block diagram of a second embodiment of a high-efficiency switching power converter in accordance with the present invention;

FIG. 5 is a circuit block diagram of a third embodiment of a high-efficiency switching power converter in accordance with the present invention;

FIG. 6 is a circuit block diagram of a fourth embodiment of a high-efficiency switching power converter in accordance with the present invention; and

FIG. 7 is a circuit block diagram of a fifth embodiment of a high-efficiency switching power converter in accordance with the present invention.

### DETAILED DESCRIPTION OF THE INVENTION

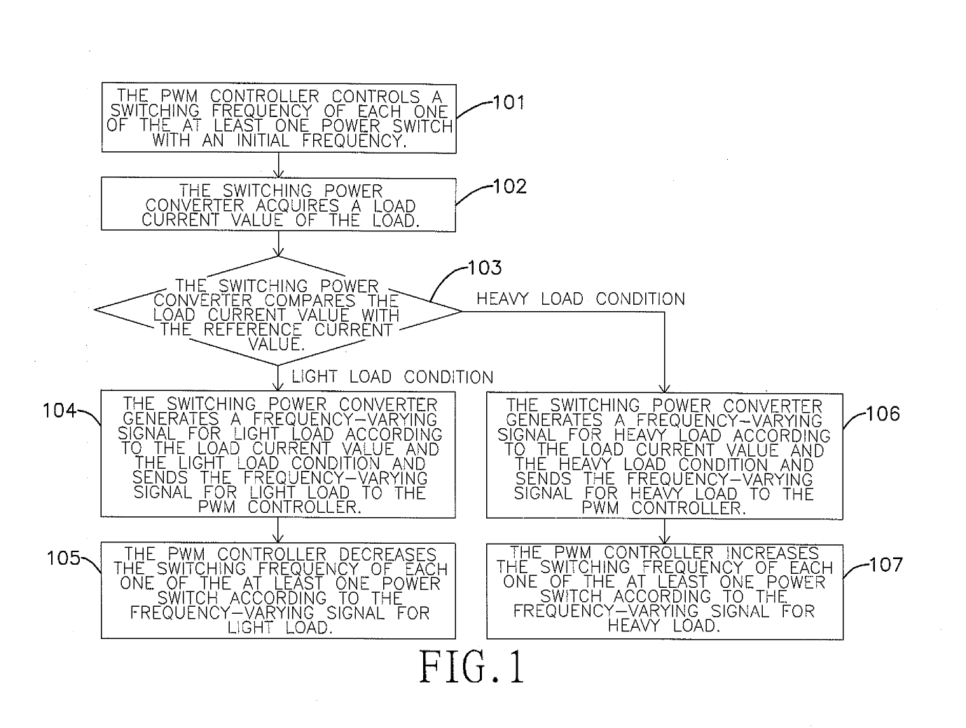

With reference to FIG. 1, a method for enhancing switching power conversion efficiency in accordance with the present invention is performed by a switching power converter. The switching power converter is connected to a load, stores a reference current value, and has a power converter and a PWM controller. The power converter has at least one power switch. The PWM controller controls a switching frequency of each one of the at least one power switch. The method has the following steps.

Step 101: The PWM controller controls a switching frequency of each one of the at least one power switch with an initial frequency.

Step 102: The switching power converter acquires a load current value of the load.

Step 103: The switching power converter compares the load current value with the reference current value.

Step 104: If the load current value is less than the reference current value or is in a light load condition, the switching power converter generates a frequency-varying signal for light load according to the load current value and the light load condition and sends the frequency-varying signal for light load to the PWM controller.

Step 105: The PWM controller decreases the switching frequency of each one of the at least one power switch according to the frequency-varying signal for light load.

Step 106: If the load current is greater than the reference current or in a heavy load condition, the switching power converter generates a frequency-varying signal for heavy load according to the load current value and the heavy load condition and sends the frequency-varying signal for heavy load to the PWM controller.

Step 107: The PWM controller increases the switching frequency of each one of the at least one power switch according to the frequency-varying signal for heavy load.

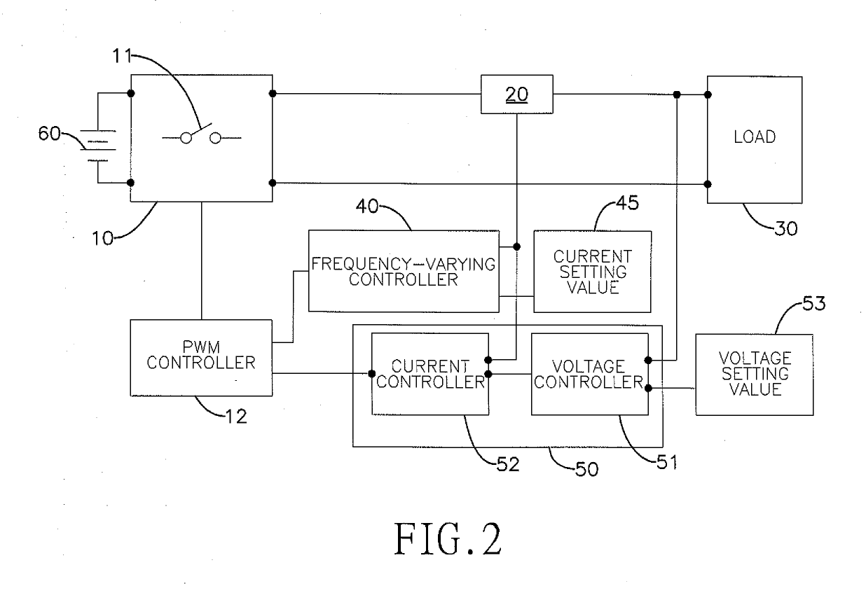

With reference to FIG. 2, a first embodiment of a high-efficiency switching power converter in accordance with the present invention has a power converter 10, a current detector 20, a frequency-varying controller 40, a feedback circuit 50 and a PWM controller 12. The power converter 10 has at least one power switch 11, a set of input terminals and a set of output terminals connected to a load 30. The set of input terminals is connected to a DC power source 60. The set of output terminals is connected to a load 30. The current detector 20 is serially connected between the power converter 10 and the load 30. The frequency-varying controller 40 is connected to the current detector 20 and receives at least one current setting value 45. The feedback circuit 50 is connected to the current detector 20 and the load 30. The PWM controller 12 is connected to the frequency-varying controller 40, the feedback circuit 50 and the power converter 10.

The DC power source 60 is connected to the load 30 through the power converter 10. The PWM controller 12 outputs a first frequency to control the switching frequency of each one of the at least one power switch 11. The current detector 20 detects a load current from the load 30 and outputs the value of the load current to the frequency-varying controller 40. The value of the load current is compared with the at least one current setting value 45 serving as a basis for determining if the load 30 is a light load or a heavy load. After the frequency-varying controller 40 determines that the load is a light load or a heavy load, a frequency-varying signal for light load or heavy load is sent to the PWM controller 12. The feedback circuit 50 generates a feedback signal and sends it to the PWM controller 12. The PWM controller 12 outputs a second frequency according to the feedback signal and the frequency-varying signal for light load or heavy load to the power converter 10 to adjust the switching frequency of each one of the at least one power switch 11. In the case of light load, the second frequency is set to be lower than the first frequency to reduce the switching frequency of each one of the at least one power switch 11 for the purpose of diminishing switching loss. In the case of heavy load, the second frequency is set to be higher than the first frequency to reduce the ripple of the load current.

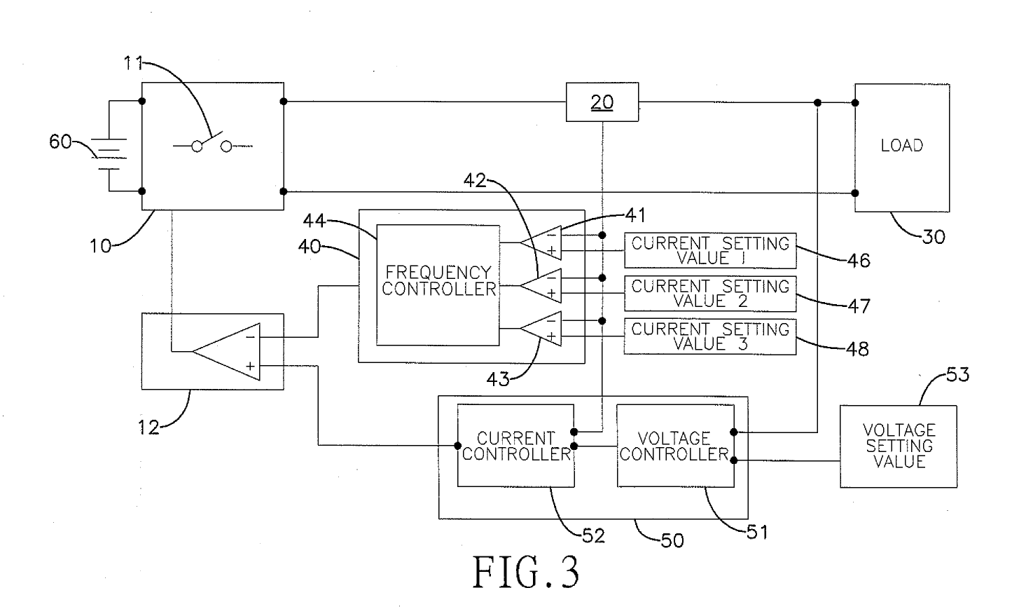

With reference to FIG. 3, the power converter 10 has two input terminals, two output terminals and at least one control terminal. The two input terminals are connected to a DC power source 60. The two output terminals are connected to a load 30. The at least one power switch 11 is connected between the two input terminals and the two output terminals. The at least one control terminal serves to respectively turn on or off the at least one power switch 11.

The current detector 20 has two input terminals and an output terminal. The two terminals are respectively connected to one of the output terminals of the power converter 10 and one of the input terminals of the load 30 to detect the load current of the load 30.

The frequency-varying controller 40 has multiple input terminals and an output terminal. One of the input terminals is connected to the output terminal of the current detector 20. The at least one current setting value 45 is respectively inputted to the rest of input terminals. In the present embodiment, there are three current setting values I₁, I₂ and I₃, and I₁<I₂ and I₂<I₃. The frequency-varying controller 40 has a frequency controller 44 and three comparators 41, 42 and 43. The frequency controller 44 has multiple input terminals. The first comparator 41 has two input terminals and an output terminal. One of the input terminals is connected to the output terminal of the current detector 20 to acquire the value of the load current, the current setting value I₁ 46 is inputted to the other input terminal, and the output terminal is connected to one of the input terminals of the frequency controller 44. When the load current is less than or equal to the current setting value I₁ 46, the first comparator 41 outputs a signal to the frequency controller 44 for the frequency controller 44 to output a low-frequency frequency-varying signal for light load. Similarly, the third comparator 43 also has two input terminals and an output terminal. The current setting value I₃ 48 is inputted to one of the input terminals. When the load current is greater than or equal to the current setting value I₃ 48, the third comparator 43 outputs a signal to the frequency controller 44 for the frequency controller 44 to output a high-frequency frequency-varying signal for heavy load. The second comparator 42 has two input terminals and an output terminal. The current setting value I₂ 47 is inputted to one of the input terminals. When the load current is greater than the current setting value I₃ 46, equal to the current setting value I₂ 47 or less than the current setting value I₃ 48, the second comparator 42 outputs a signal to the frequency controller 44 for the frequency controller 44 to output a middle-frequency frequency-varying signal having a frequency between those of the high-frequency frequency-varying signal and the low-frequency frequency-varying signal.

The feedback circuit 50 has three input terminals, an output terminal, a voltage controller 51 and a current controller 52. One of the input terminals is connected between one of the output terminals of the power converter 10 and the load 30 to acquire the load voltage of the load 30. Another input terminal is connected to an output terminal of the current detector 20 to acquire the current of the load 30. A voltage setting value 53 is inputted to the remaining input terminal. The voltage controller 51 compares the load voltage with the voltage setting value 53. When the load voltage is less than the voltage setting value 53, the load 30 is a heavy load and the voltage controller 51 outputs a heavy-load voltage control signal. When the load voltage is greater than the voltage setting value 53, the load 30 is a light load and the voltage controller 51 outputs a light-load voltage control signal. After acquiring the heavy-load or light-load voltage control signal and the load current, the current controller 52 determines a loading condition of the load 30 and outputs a feedback control signal from its output terminal.

The PWM controller 12 has at least one output terminal, a feedback control terminal and a frequency control signal terminal. The at least one output terminal is connected to at least one control terminal of the power converter 10 to control the at least one power switch inside the power converter 10. The frequency control signal terminal is connected to the output terminal of the frequency-varying controller 40.

After receiving the frequency-varying signal for light load outputted from the frequency-varying controller 40 and the feedback control signal for light load outputted from the feedback circuit 50, the PWM controller 12 outputs the second frequency, which is lower than the first frequency for the purpose of lowering the switching frequency of each one of the at least one power switch 11 and reducing the pulse width for the switching frequency. After receiving the frequency-varying signal for heavy load outputted from the frequency-varying controller 40 and the feedback control signal for heavy load outputted from the feedback circuit 50, the PWM controller 12 outputs the second frequency, which is higher than the first frequency for the purpose of raising the switching frequency of each one of the at least one power switch 11 and increasing the pulse width for the switching frequency.

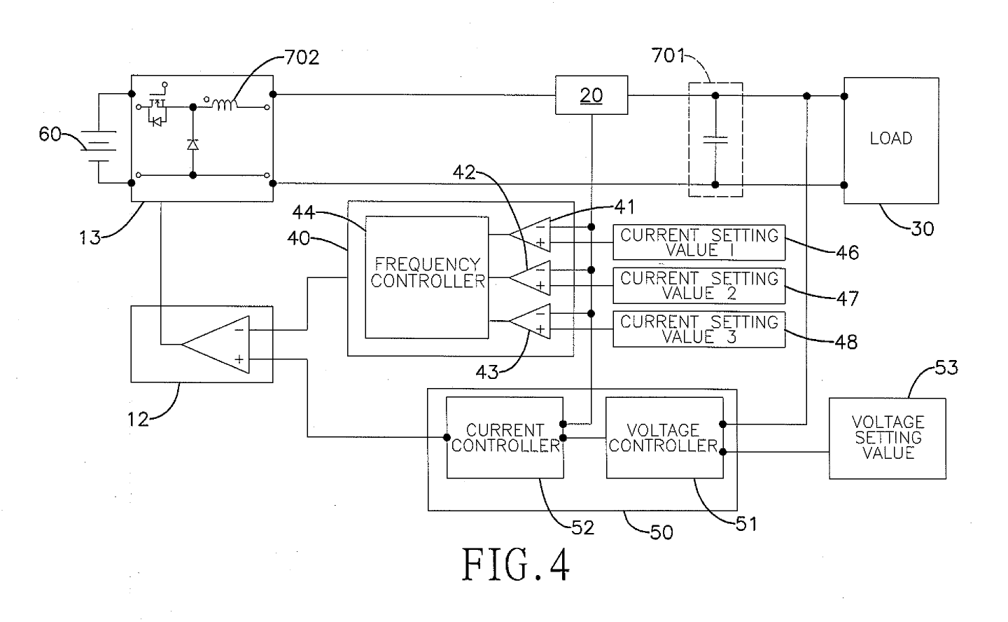

With reference to FIG. 4, a second embodiment of a high-efficiency switching power converter in accordance with the present invention is roughly the same as the first embodiment except that the power converter 10 in the present embodiment is a buck converter 13 converting DC input power into DC output power, the buck converter 13 has a filtering circuit, the filtering circuit has a capacitor 701 and an inductor 702, the capacitor 701 is parallelly connected between two input terminals of the load 30, the inductor 702 is connected to one of the output terminals of the buck converter 13, and the two input terminals of the current detector 20 are respectively connected to one end of the inductor 702 and one of the input terminals of the load 30.

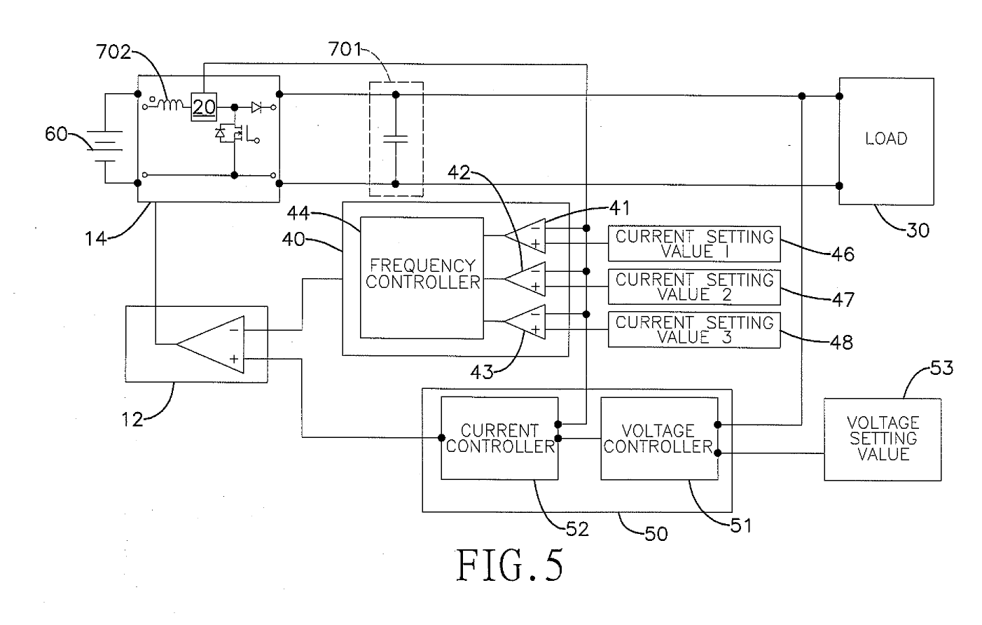

With reference to FIG. 5, a second embodiment of a high-efficiency switching power converter in accordance with the present invention is roughly the same as the first embodiment except that the power converter 10 in the present embodiment is a boost converter 14 converting DC input power into DC output power, the inductor 702 is connected to one of the output terminals of the boost converter 14, the current detector 20 is located inside the boost converter 14 and is serially connected to the inductor 702 so that the current detector 20 can detect current through the inductor 702 and use the current to determine if the load 30 is a light load or a heavy load, the two output terminals of the boost converter 14 are connected to a filtering circuit, and the filtering circuit has a capacitor 701 parallelly connected to the two output terminals of the boost converter 14.

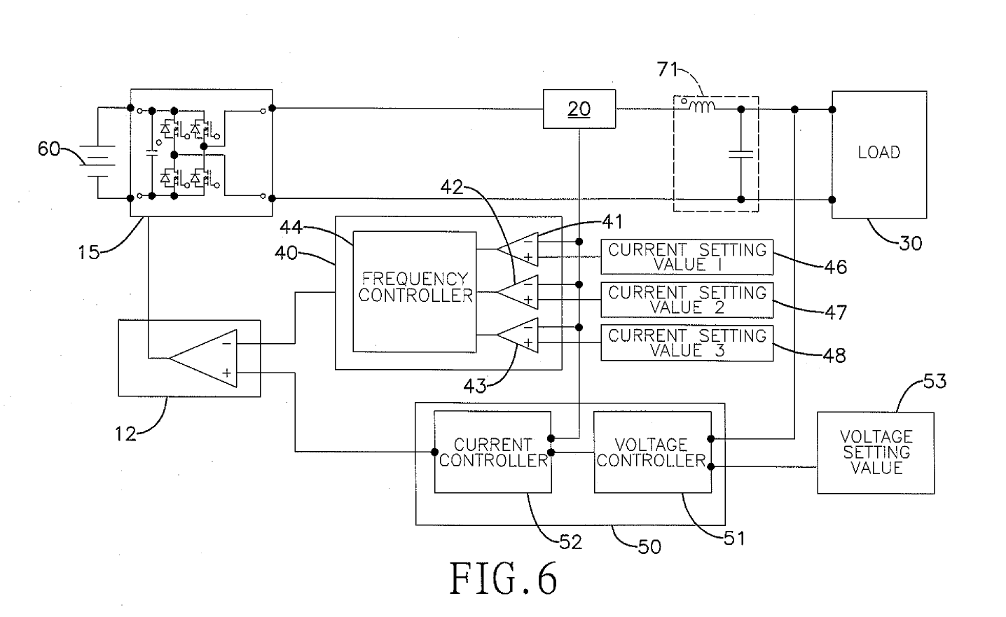

With reference to FIG. 6, a fourth embodiment of a high-efficiency switching power converter in accordance with the present invention is roughly the same as the first embodiment except that the power converter 10 in the present embodiment is a full-bridge inverter 15 converting DC input power into AC output power, an energy storage and filtering circuit 71 is connected between the current detector 20 and one of the two input terminals of the load 30 and has an inductor and a capacitor, the inductor is serially connected between the current detector 20 and the input terminal of the load 30, and the capacitor is parallelly connected between the two input terminals of the load 30.

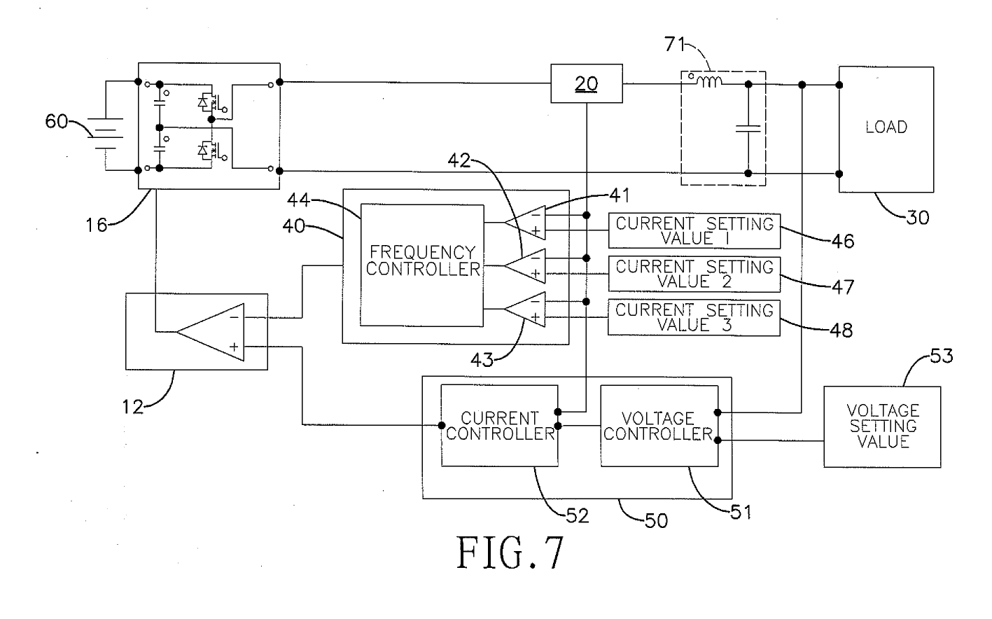

With reference to FIG. 7, a fifth embodiment of a high-efficiency switching power converter in accordance with the present invention is roughly the same as the first embodiment except that the power converter 10 in the present embodiment is a half-bridge inverter 16 converting DC input power into AC output power, an energy storage and filtering circuit 71 is connected between the current detector 20 and one of the two input terminals of the load 30 and has an inductor and a capacitor, the inductor is serially connected between the current detector 20 and one of the input terminals of the load 30, and the capacitor is parallelly connected between the two input terminals of the load 30.

The characteristics and benefits of the present invention can be summarized as follows. After determining if the load 30 is a light load or a heavy load according to the load current, the frequency-varying controller 40 outputs a frequency-varying signal for light load or heavy load. The PWM controller 12 then alters the switching frequency of the at least one power switch 11 to reduce the switching loss and the output ripple. Additionally, the power converter 10 can be applicable to various types of converters and inverters to enhance the conversion efficiency of the switching power converter.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A high-efficiency switching power converter comprising:
a power converter having:
two input terminals adapted to connect to a DC power source;
two output terminals adapted to connect to a load;
at least one power switch connected between the two input terminals and the two output terminals; and
at least one control terminal controlling the at least one power switch to switch;
a current detector having:
two input terminals respectively connected to the power converter and the load; and
an output terminal;
a frequency-varying controller having:
multiple input terminals, one of the input terminals connected to the output terminal of the current detector and the remaining input terminals respectively receiving at least one current setting value; and
an output terminal;
a feedback circuit having:
three input terminals, two of the three input terminals respectively connected to one of the output terminals of the power converter and the output terminal of the current detector, and the remaining input terminal receiving a voltage setting value; and
an output terminal; and
a PWM controller having:
at least one output terminal respectively connected to the at least one control terminal of the power converter;
a feedback control terminal connected to the output terminal of the feedback circuit; and
a frequency control signal terminal connected to the output terminal of the frequency-varying controller.

2. The high-efficiency switching power converter as claimed in claim 1, wherein the frequency-varying controller has:
at least one comparator, each one of the at least one comparator having:
two input terminals, one of the two input terminals connected to one of the at least one current setting value; and
an output terminal; and
a frequency controller having at least one input terminal connected to the respective output terminal of the at least one comparator.

3. The high-efficiency switching power converter as claimed in claim 1, wherein the power converter is a buck converter converting DC power inputted from the DC power source into DC power and outputting the converted DC power, the buck converter has a filtering circuit connected between the two output terminals of the buck converter, and the filtering circuit has a capacitor and an inductor.

4. The high-efficiency switching power converter as claimed in claim 2, wherein the power converter is a buck converter converting DC power inputted from the DC power source into DC power and outputting the converted DC power, the buck converter has a filtering circuit connected between the two output terminals of the buck converter, and the filtering circuit has a capacitor and an inductor.

5. The high-efficiency switching power converter as claimed in claim 1, wherein the power converter is a boost converter converting DC power inputted from the DC power source into DC power and outputting the converted DC power, the boost converter has a filtering circuit connected between the two output terminals of the boost converter, and the filtering circuit has an inductor.

6. The high-efficiency switching power converter as claimed in claim 2, wherein the power converter is a boost converter converting DC power inputted from the DC power source into DC power and outputting the converted DC power, the boost converter has a filtering circuit connected between the two output terminals of the boost converter, and the filtering circuit has an inductor.

7. The high-efficiency switching power converter as claimed in claim 1, wherein the power converter is a full-bridge inverter converting DC power inputted from the DC power source into AC power and outputting the converted AC power, the full-bridge inverter has an energy storage and filtering circuit connected between the two output terminals of the full-bridge inverter and the load, and the filtering circuit has an inductor and a capacitor.

8. The high-efficiency switching power converter as claimed in claim 2, wherein the power converter is a full-bridge inverter converting DC power inputted from the DC power source into AC power and outputting the converted AC power, the full-bridge inverter has an energy storage and filtering circuit connected between the two output terminals of the full-bridge inverter and the load, and the filtering circuit has an inductor and a capacitor.

9. The high-efficiency switching power converter as claimed in claim 1, wherein the power converter is a half-bridge inverter converting DC power inputted from the DC power source into AC power and outputting the converted AC power, the half-bridge inverter has an energy storage and filtering circuit connected between the two output terminals of the half-bridge inverter and the load, and the filtering circuit has an inductor and a capacitor.

10. The high-efficiency switching power converter as claimed in claim 2, wherein the power converter is a half-bridge inverter converting DC power inputted from the DC power source into AC power and outputting the converted AC power, the half-bridge inverter has an energy storage and filtering circuit connected between the two output terminals of the half-bridge inverter and the load, and the filtering circuit has an inductor and a capacitor.

11. A method for enhancing switching power conversion efficiency performed by a switching power converter connected to a load, storing a reference current value, and having a power converter having at least one power switch and a PWM controller controlling a switching frequency of each one of the at least one power switch, the method comprising the following steps:
the PWM controller controlling a switching frequency of each one of the at least one power switch with an initial frequency;
the switching power converter acquiring a load current value of the load;
the switching power converter comparing the load current value with the reference current value;
the switching power converter generating a frequency-varying signal according to the load current value and the comparison result and sending the frequency-varying signal to the PWM controller; and
the PWM controller decreasing or increasing the switching frequency of each one of the at least one power switch according to the frequency-varying signal.

12. The method as claimed in claim 11, wherein if the load current value is less than the reference current value or is in a light load condition, the switching power converter generates a frequency-varying signal for light load according to the load current value and the light load condition and sends the frequency-varying signal for light load to the PWM controller.

13. The method as claimed in claim 11, wherein if the load current is greater than the reference current or is in a heavy load condition, the switching power converter generates a frequency-varying signal for heavy load according to the load current value and the heavy load condition and sends the frequency-varying signal for heavy load to the PWM controller, and the PWM controller increases the switching frequency of each one of the at least one power switch according to the frequency-varying signal for heavy load.
